(19) United States
(12) Patent Application Publication
(10) Pub. No.: US 2014/0376468 A1
(43) Pub. Date: Dec. 25, 2014

(54) METHOD FOR UL DATA TRANSMISSION IN WIRELESS COMMUNICATION SYSTEM

(71) Applicant: Samsung Electronics., Ltd., Gyeonggi-do (KR)

(72) Inventors: Hong He, Beijing (CN); Yingyang Li, Beijing (CN); Chengjun Sun, Beijing (CN)

(21) Appl. No.: 14/346,273

(22) PCT Filed: Sep. 20, 2012
(86) PCT No.: PCT/KR2012/007512

§ 371 Date: Mar. 20, 2014

(30) Foreign Application Priority Data
Sep. 20, 2011 (CN) 201110288951.X

(51) Int. Cl. H04W 72/04; H04L 5/00; H04B 1/713

(52) U.S. Cl. CPC H04W 72/0406; H04B 1/713; H04L 5/0055
USPC 370/329

(57) ABSTRACT

The present invention provides a UL data transmission method in a wireless communication system, including determining, by the UE, UL virtual resources allocated to the UE by the eNB according to Downlink Control Information (DCI) used for scheduling UL physical resources sent from the eNB to the UE; determining, by the UE, the UL physical resources used for transmitting the UL data after frequency hopping processing in a preset frequency domain when determining that the UL data needs to be processed with frequency hopping processing according to the DCI, if the UL virtual resources allocated to the UE locate at UL sub-frames in a non-aggregation K of any wireless frame, and locate at the preset frequency domain; bearing, by the UE, the UL data and feeding the UL data back to the eNB utilizing the determined UL physical resources which are processed with the frequency hopping processing and used for transmitting the UL data. With the present invention, the PUSCH channel resource collision may be avoided, the frequency diversity gain may be maximized, and the PUSCH performances may be enhanced.

### TECHNICAL FIELD

The present invention relates to wireless communication technologies, and more particularly, to a method for UL (Uplink) data transmission in a wireless communication system.

### BACKGROUND ART

In the existing Long Term Evolution (LTE) standard of the 3rd Generation Partnership Project (3GPP), a DL (Downlink) transmission technology is based on Orthogonal Frequency Division Multiplexing (OFDM) while a UL transmission technology is based on Single-Carrier Frequency Division Multiple Access (SC-FDMA). The LTE system uses two types of frame structure, i.e., frame structure type 1 adopting Frequency-Division Duplex (FDD) and frame structure type 2 adopting Time Division Duplex (TDD). Frame structure type 2 includes seven kinds of different frame structure configurations. The proportion of DL sub-frames in each kind of frame structure configuration is fixed, ranging from 40% to 90%. As shown in FIG. 1, sub-frames identified with “D” are DL sub-frames, sub-frames identified with “U” are UL sub-frames and sub-frames identified with “slashes” are special Sub-frames.

The DL data sub-frames Physical Downlink Shared Channel (PDSCH) are used for transmitting DL data, and Acknowledgement (ACK)/Negative Acknowledgement (NACK) information corresponding to the PDSCH is fed back with Physical Uplink Control Channel (PUCCH) of UL control sub-frames. Downlink Control Information (DCI) corresponding to the DL data is borne by a CCE (Control Channel Element) aggregation on a Physical Downlink Control Channel (PDCCH). Existing mapping method of ACK/NACK corresponding to the PDSCH include an implicit mapping method and an explicit mapping method. Where, the implicit mapping method includes:

First, positions of Physical Uplink Control Channel (PUCCH) sub-frames for feeding back the ACK/NACK information are determined according to positions of PDSCH sub-frames. Then, specific resources positions of the ACK/NACK information which is fed back in the corresponding PUCCH sub-frames are determined according to a position of the first CCE in the CCE aggregation of the DCI information bearing the DL data. The above implicit mapping method directly indicates the resource positions of the ACK/NACK without extra information. Thus, overheads are saved and resources utilization rate is enhanced.

In order to further meet the requirement of enhancing data speed, a conception of Carrier Aggregation (CA) is introduced into version 10 (Rel-10) of the LTE. Multiple continuous or discontinuous bandwidth carriers are aggregated into system bandwidth up to 100 Mhz. Specifically, in the LTE Rel-10 system, the UE may be configured with multiple Component Carriers (CC)s. An evolved Node B (eNB) notifies the UE of a number of a Primary CC (PCC) and numbers of aggregated Secondary CCs (SCC)s through high-level signaling. At the same time, along with the development of actual network deployment and system operations, in the future evolution of the Time Division (TD)-LTE system, the problem that different CCs adopts different sub-frame configurations becomes an important problem needing to be taken into account in the evolution of the TD-LTE system.

When the multiple CCs configured for the UE are in different frequency bands, and the frame structure configuration of at least one CC is different from the frame structure of other CCs, how to design a timing relationship between PDSCH of a DL data sub-frame and UL control information, and more specifically how to design the timing relationship between the PDSCH and the ACK/NACK information becomes a key issue to be solved when the carrier aggregation technologies of different bands adopt different frame structure configurations.

At present, on the basis of rational technical analysis, there are mainly two potential technical routes.

The first method for feeding back the ACK/NACK is on an assumption that all UEs supporting a carrier aggregation technology of different bands and characteristics of different frame structure configurations include at least two Power Amplifiers (PA)s and Radio frequency (RF) circuits. When all CCs of the UE are in two different bands and the frame structure configurations in any different band are the same, while the frame structure in different bands is different, the eNB designates a CC for feeding back ACK/NACK information for each UE in each band through the high-level signaling. Each band continues to use an existing timing relationship between the PDSCH and UL ACK/NACK in its band according to its different frame structure configurations. As shown in FIG. 2, the problem of the first method lies in that the costs of the Rel-11 terminals are greatly enhanced, and the realization and markets of the Rel-11 products are restricted. Meanwhile, how to support the power control of cell edge users with limited power and UL ACK/NACK is also a problem to be solved by the first method.

As for the problems of the first method, the second method merely sending the UL ACK/NACK information on a single PCC to ensure that even low-end users with only one PA in the Rel-11 system still can benefit from the carrier aggregation technology of different bands with different frame structure configurations, and continue to use the existing power control mechanism of the UL ACK/NACK information.

In the second method, the typical method is designing a new timing relationship between the PDSCH and UL ACK/NACK. However, a scheduler needs to use a new scheduling policy for allocating and scheduling resources, i.e., the method needs to change the existing scheduler algorithms.

The second method further includes an improved method: The UE determines positions of public UL sub-frames according to the frame structure configurations of configured CCs, searches for and determines a unique and backward compatible frame structure configuration according to the positions of the public UL sub-frames, and at last, maps the specific timing relationship between the PDSCH and UL ACK/NACK out one by one on the PCC configured by the UE according to the determined backward compatible frame structure configuration. The UE uses the above method for effectively supporting the carrier aggregation of Bands of different frame structure configurations and implementing coexistence and performance optimization of different communication systems without limiting the number of amplifiers of the UE. As shown in FIG. 3, when the UE configures two different CCs on two different frequency bands, one of the CC is the PCC adopting frame structure configuration 1, and the other is SCC adopting frame structure configuration 2. The UE decides to feed back the ACK/NACK information corresponding to the PDSCH on the PCC and SCCs adopting the timing relationship between the PDSCH and ACK/NACK defined by frame structure configuration 2 according to the above method.

For the convenience of description, UL sub-frames in any wireless frame are divided into two categories according to whether the ACK/NACK information of Rel-11 is borne. One of the categories specifically indicates UL sub-frames for transmitting the ACK/NACK information of different frame structure configurations on different CCs, and this category is called type I UL sub-frames, and the other UL sub-frames are called type II UL sub-frames. Here, Rel-11 ACK/NACK specifically indicates the ACK/NACK information generated when different CCs adopt different frame structure configurations. More specifically, as shown in FIG. 3, when the cell adopts frame structure 1 on the PCC while adopts frame structure 2 on the SCC, sub-frame 2 and sub-frame 7 in any wireless frame are type I UL data sub-frames, while both sub-frame 3 and sub-frame 8 are type II UL data sub-frames.

As for the wireless frame including the type I and type II UL data sub-frames, the ACK/NACK loads of the type I UL data sub-frames are different from those of the type II UL data sub-frames, resulting in that the UL overheads of the two kinds of UL data sub-frames are different. In the type II UL data sub-frames, since the ACK/NACK causes a relatively light load, thus much more resources are used for transmitting the UL data. That is to say, compared with the type I UL sub-frames, the PUSCH of the type II UL sub-frames occupies much more resources. As shown in FIG. 4, the loads of the ACK/NACK of sub-frames 7 and sub-frame 8 are different, resulting in that the UL overheads of two continuous sub-frames are different. Specifically, in sub-frame 8, the ACK/NACK causes a relatively light load, the PUSCH R1 area taken as PUSCH is used for transmitting the UL data, while in sub-frame 7, the ACK/NACK causes a relatively heavy load, the frequency domain which is identical with the PUSCH R1 area in sub-frame 8 is taken as the PUCCH and used for transmitting the control information. At present, in the UL data transmission of the PUSCH, a frequency hopping method may be used for transmission according to system settings. In sub-frame 8, the PUSCH R1 area is also taken as the PUSCH. The frequency domain resources occupied by the UL data may fall into area 403 in FIG. 4, and may collide with the frequency resources occupied by other UL data in this area after the UL data in this area is processed with the frequency hopping. That is to say, PUSCH402 after the frequency hopping processing may collide with PUSCH401.

### DISCLOSURE OF INVENTION

### Technical Problem

The present invention provides a UL data transmission method in a wireless communication system, to ensure the transmission of the PUSCH without collision while ensuring the obtaining the frequency domain diversity gain with the frequency hopping.

### Solution to Problem

In order to achieve the above objective, the present invention adopts the following technical scheme:

A method for uplink (UL) data transmission in a wireless communication system, when there are at least two Component Carriers (CC)s whose frame structure configurations are different from each other in CCs configured for a User Equipment (UE), the method includes:

determining, by the UE, UL virtual resources allocated to the UE by the eNB according to Downlink Control Information (DCI) used for scheduling UL physical resources sent from the eNB to the UE;

determining, by the UE, the UL physical resources used for transmitting the UL data after frequency hopping processing in a preset frequency domain when determining that the UL data needs to be processed with frequency hopping processing according to the DCI, if the UL virtual resources allocated to the UE locate at UL sub-frames in a non-aggregation K of any wireless frame, and locate at the preset frequency domain;

bearing, by the UE, the UL data and feeding the UL data back to the eNB utilizing the determined UL physical resources which are processed with the frequency hopping processing and used for transmitting the UL data;

wherein the aggregation K is an aggregation of UL sub-frames which are determined according to configured and different CC frame structure configurations and used for feeding back Acknowledgment/Negative Acknowledgement (ACK/NACK) information; and the preset frequency domain is an overlapping area of a Physical Uplink Control Channel (PUCCH) area of UL sub-frames in the aggregation K and a Physical Uplink Shared Channel (PUSCH) area of sub-frames in the non-aggregation K.

Preferably, a method for determining whether the UL virtual resources allocated to the UE locate at the preset frequency domain includes: determining whether a UL virtual resource block m allocated to the UE satisfies a condition

$$m < {N}_{RB}^{HO} / 2 or m > {N}_{RB}^{UL} - \frac{{N}_{RB}^{HO}}{2} ;$$

determining that the UL virtual resources allocated to the UE locate at the preset frequency domain if the UL virtual resource block m satisfies the condition; otherwise determining that the UL virtual resources allocated to the UE do not locate at the preset frequency domain; wherein

N_{RB}^{UL} is a total number of Resource Blocks (RB)s in a UL system bandwidth, and

N_{RB}^{HO} is an offset of frequency hopping issued by the system.

Preferably, the method for determining, by the UE, the UL physical resources used for transmitting the UL data after the frequency hopping processing in the preset frequency domain includes: n_{PRB}^{s2}(i)=N_{RB}^{UL}=1−n_{PRB}^{s1}, wherein n_{PRB}^{s2}(i) is a position of a UL physical resource which is used for transmitting the UL data after the frequency hopping processing, n_{PRB}^{s1}(i) is a position of a UL virtual resource allocated to the UE, N_{RB}^{UL} is a total number of RBs in the UL system bandwidth, and i is a number of the UL virtual resources allocated to the UE.

It can be seen from the above technical scheme that in the present invention, after the UE determines the UL physical resources allocated to itself by the eNB, when if it is determined that the allocated physical resources locate at the PUSCH R1 area of the type II UL sub-frames, if the UL data needs to be processed with the frequency hopping processing, the UE determines the actual positions of the physical resources after the frequency hopping processing in the PUSCH R1 area. Thus, the physical resources in the PUSCH R1 area are still mapped into the PUSCH R1 area after the frequency hopping processing, to avoid the collision with the PUSCH in the non-R1 area.

### Advantageous Effects of Invention

According to the present invention, a UL data transmission method in a wireless communication system, to ensure the transmission of the PUSCH without collision while ensuring the obtaining the frequency domain diversity gain with the frequency hopping is provided.

### BRIEF DESCRIPTION OF DRAWINGS

FIG. 1 is a figure illustrating configurations of frame structure of an existing TD-LTE system;

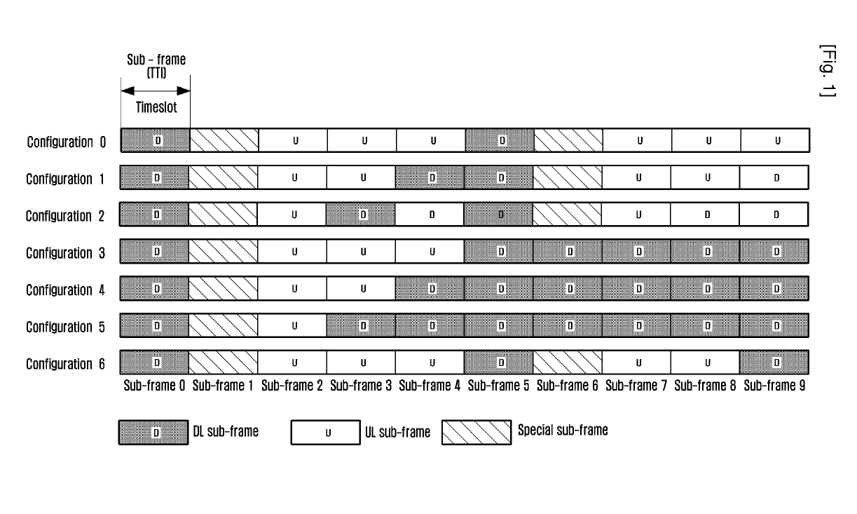

FIG. 2 is a schematic diagram illustrating a first method for feeding back ACK/NACK information;

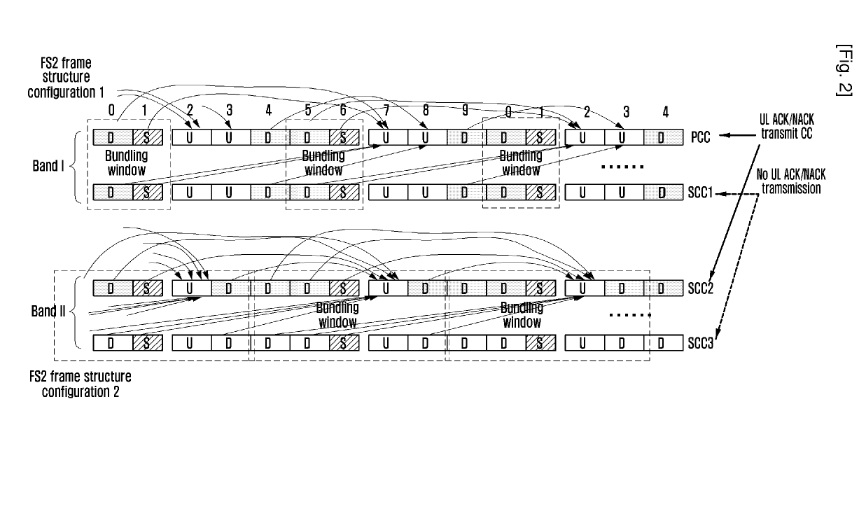

FIG. 3 is a schematic diagram illustrating an improved method of a second method for feeding back ACK/NACK;

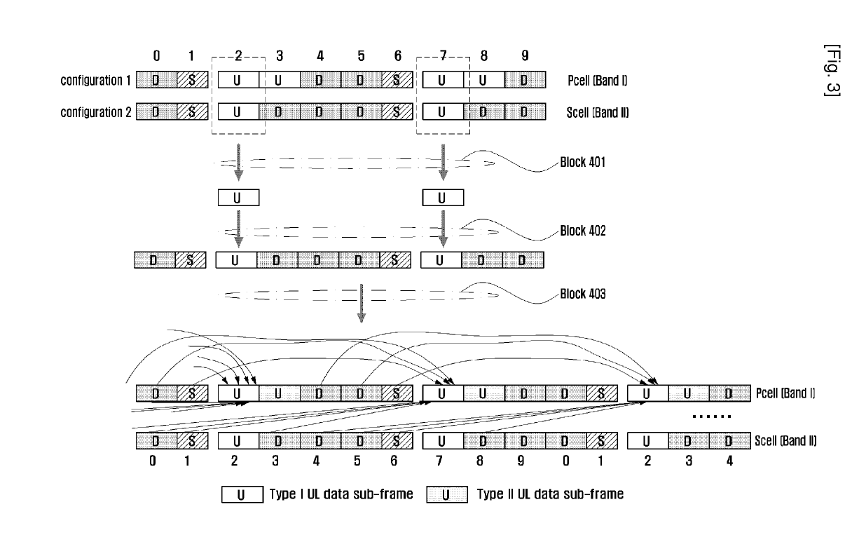

FIG. 4 illustrates descriptions of problems in the improved method of the second method for feeding back ACK/NACK;

FIG. 5 is a whole flow chart illustrating a UL data transmission method in accordance with an embodiment of the present invention; and

FIG. 6 is a schematic diagram illustrating mapping of resources used for transmitting UL data in accordance with an embodiment of the present invention.

### MODE FOR THE INVENTION

The present invention is further described in detail hereinafter with reference to the accompanying drawings to make the objective, technical solution and merits thereof more apparent.

The basic idea of the present invention is still mapping resource blocks in a PUSCH R1 area of type II UL sub-frames into the PUSCH R1 area after frequency hopping processing to avoid the collision with the PUSCH of non-R1 area.

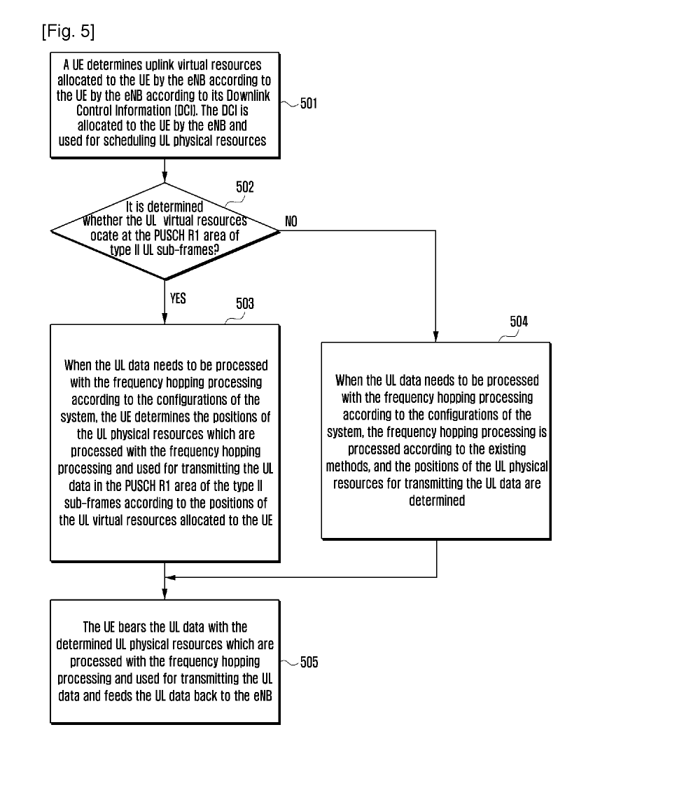

FIG. 5 is a whole flow chart illustrating a UL data transmission method in accordance with an embodiment of the present invention. As for the UE configured with CCs which are configured with multiple different frame structure configurations, the UL data is transmitted adopting the method shown in FIG. 5. Specifically, as shown in FIG. 5, the method includes:

Block 501: A UE determines uplink virtual resources allocated to the UE by the eNB according to its Downlink Control Information (DCI). The DCI is allocated to the UE by the eNB and used for scheduling UL physical resources.

The processing of this block is identical with that in the prior art.

Block 502: It is determined whether the UL virtual resources allocated to the UE locate at the PUSCH R1 area of type II UL sub-frames. Block 503 is executed is yes; otherwise block 504 is executed.

As stated in the background of the invention, type II UL sub-frames refer to UL sub-frames except for type I UL sub-frames. While type I UL sub-frames refer to UL sub-frames for transmitting ACK/NACK information of different frame structure configurations of different CCs. Therefore, if an aggregation K is formed with the UL sub-frames for transmitting ACK/NACK information of different frame structure configurations of different CCs, type I UL sub-frames refer to UL sub-frames in the aggregation K, while type II UL sub-frames refer to UL sub-frames which are not in the aggregation K.

Because the PUSCH R1 area for transmitting the UL data is added to the PUSCH in the type II UL sub-frames, physical resources, after the frequency hopping processing, in the added PUSCH R1 area may collide with resource blocks and physical resource blocks after the frequency hopping processing in the non-R1 area. Therefore, the UL virtual resources in the PUSCH R1 area in the type II UL sub-frames allocated to the UE by the system need to be processed in block 503 to avoid the collision. While, other UL virtual resources allocated to the UE by the system need to be processed according to an existing method in block 504.

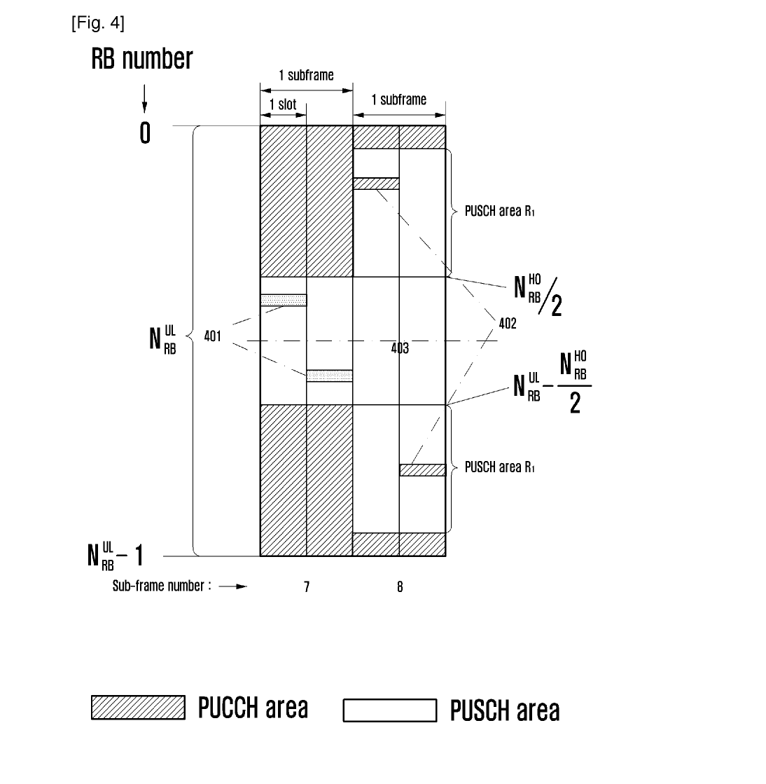

As shown in FIG. 4, the PUSCH R1 area is an overlapping area of the PUCCH of type I UL sub-frames and the PUSCH of type II UL sub-frames. When determining whether the UL virtual resources allocated to the UE locate at the PUSCH R1 area of type II UL sub-frames, the determination of whether allocated UL virtual resources locate at the type II UL sub-frames may be performed according to an existing method, and the method for determining whether the allocated UL virtual resources locate at the PUSCH R1 area includes determining whether the UL virtual resource block m allocated to the UE satisfy the following condition:

$$\begin{matrix}m < {N}_{RB}^{HO} / 2 \\ or & ( 1 ) \\ m > {N}_{RB}^{UL} - \frac{{N}_{RB}^{HO}}{2} . & ( 2 )\end{matrix}$$

N_{RB}^{UL} is a total number of Resource Blocks (RB)s in the UL system band, and N_{RB}^{HO} is a frequency hopping offset issued by the system.

If any of the above conditions is satisfied, it is determined that the UL virtual resources allocated to the UE locate at the PUSCH R1 area; otherwise, it is determined that the UL virtual resources allocated to the UE do not locate at the PUSCH R1 area. It can be seen from FIG. 4 that actually, the PUSCH R1 area not only refers to an area of

$$m < {N}_{RB}^{HO} / 2 or m > {N}_{RB}^{UL} - \frac{{N}_{RB}^{HO}}{2} .$$

However, other PUCCH resources in this area are not scheduled by the system for the UE. Therefore, resources which are scheduled for the UE by the system and satisfy one of the above conditions must be those in the PUSCH R1 area.

Block 503: When the UL data needs to be processed with the frequency hopping processing according to the configuration of the system, the UE determines the positions of the UL physical resources which are processed with the frequency hopping processing and used for transmitting the UL data in the PUSCH R1 area of the type II sub-frames according to the positions of the UL virtual resources allocated to the UE.

As long as the positions of the UL physical resources which are processed with the frequency hopping processing and used for transmitting the UL data are still in the PUSCH R1 area of the type II sub-frames, the methods of the frequency hopping processing may be configured as needed. Preferably, to simply the processing of the UE, a mirroring frequency hopping mode, i.e.

n_{PRB}^{s2}(i): n_{PRB}^{s2}(i)=N_{RB}^{UL}−1−n_{PRB}^{s1}(i) may be adopted to determine the positions of the UL physical resources after the frequency hopping processing. n_{PRB}^{s1}(i) is a position of a UL physical resource allocated to the UE. N_{RB}^{UL} is the total number of RBs in the UL system bandwidth, and i is the number of the UL virtual resources allocated to the UE. This number is the number of a virtual RB allocated to the UE in all the virtual RBs allocated to the UE.

Block 504: When the UL data needs to be processed with the frequency hopping processing according to the configurations of the system, the frequency hopping processing is processed according to the existing methods, and the positions of the UL physical resources for transmitting the UL data are determined, and block 505 is executed.

Block 505: The UE bears the UL data with the determined UL physical resources which are processed with the frequency hopping processing and used for transmitting the UL data and feeds the UL data back to the eNB.

The processing of blocks 504 and 505 is identical with the conventional method and is not repeated here.

With the above processing of the embodiment of the present invention, the PUSCH R1 area of the type II UL sub-frames may bearer the UL data without collision, and the frequency-domain diversity gain may be obtained with the frequency hopping.

Next, the realization of the present invention is described through specific embodiments.

In this embodiment of the present invention, the system is configured with two carrier elements CCs, respectively numbered CC₀ and CC₁. The bandwidth of each carrier element is BWᵢ. It is assumed that BW₀=BW₁=10 MHz, i.e. each CC includes 50 Physical Resource Blocks (PRB)s, and assumed that CC₀ adopts frame structure configuration 1 while CC₁ adopts frame structure configuration 2.

The method in this embodiment includes:

Block A: eNB broadcasts relevant parameters of UL frequency hopping through system information.

The parameters of this embodiment are configured as follows: this cell adopts the intra-sub-frame frequency hopping, while the offset of the frequency hopping of the PUSCH is 30 PRBs, i.e. N_{RB}^{HO}=30.

Block B: eNB allocates the UL virtual resources of the sub-frame 2 and sub-frame 3 for the UE for transmitting the UL data.

The number of the virtual resource blocks allocated for the UE through DCI on sub-frame 2 is {26, 27, 28} (Note: the allocated resource blocks in DCI is {11, 12, 13}). The two bit value in the frequency hopping domain of DCI is “10”, and the frequency hopping processing needs to be performed. The number of the virtual resource blocks allocated for the UE through DCI on sub-frame 3 is {7, 8, 9}. The two bit value in the frequency hopping domain of DCI is “01”, and the frequency hopping processing needs to be performed.

Block C: The UE determines the UL physical resources used for transmitting the UL data according to the allocated UL virtual resources.

(└N_{RB}^{PUSCH}2┘+{26−15,27−15,28−15}) mod N_{RB}^{PUSCH}+N_{RB}^{HO}/2={16,17,18}

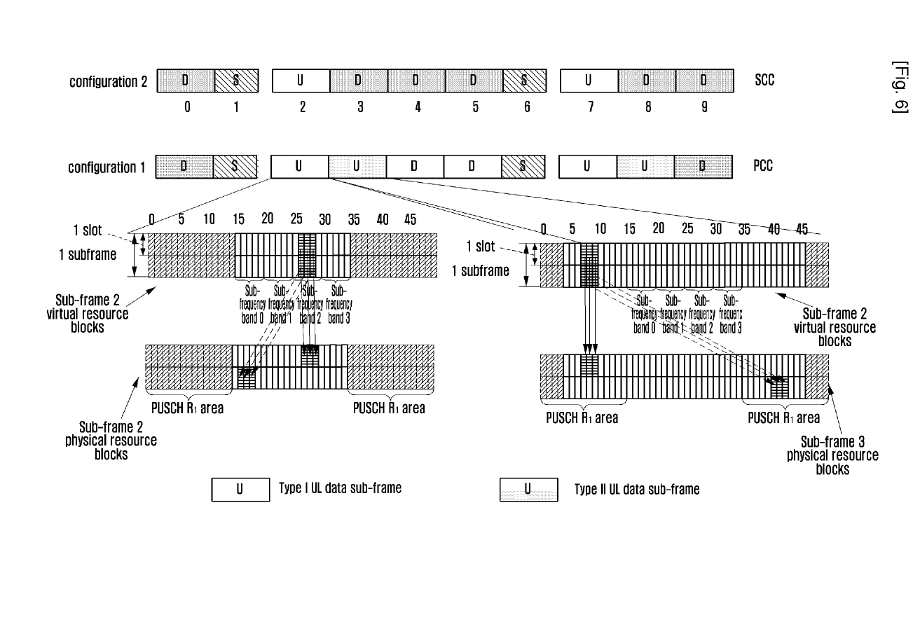

Since sub-frame 2 belongs to the type I sub-frame, the UL physical resources corresponding to the UL virtual resources allocated on sub-frame 2 are determined according to the conventional method. Specifically, as shown in FIG. 6, the UE transmits the UL data on the physical resource blocks, numbered {26, 27, 28}, at the first timeslot, while the UE maps the UL physical resources at the second timeslot adopting the conventional PUSCH frequency hopping method, i.e.

(└N_{RB}^{PUSCH}2┘+{26−15,27−15,28−15}) mod N_{RB}^{PUSCH}+N_{RB}^{HO}/2={16,17,18}

according to the existing PUSCH frequency hopping mode at the second timeslot of the same type I UL sub-frame.

In FIG. 6, in order to compare with the PUSCH R₁ area in sub-frame 3, the corresponding area in sub-frame 2 is denoted as PUSCH R₁ area. However, actually, the corresponding area in sub-frame 2 is the PUCCH area.

For sub-frame 3, it is determined that sub-frame 3 belongs to the type II UL sub-frame according to the frame structure configurations of CC0 and CC1. It is further determined whether the UL virtual resources allocated to sub-frame 3 locate at the PUSCH R1 area. Apparently, the UL resource blocks, numbered {7, 8, 9} satisfy the condition m<N_{RB}^{HO}/2. Therefore, if the UL virtual resources locate at the PUSCH R₁ area, the frequency hopping needs to be performed according to the method of the present invention. Specifically, the frequency hopping domain is “01”, the UL physical resource blocks utilized by the UE in sub-frame 3 is shown in FIG. 6.

Timeslot 0: the UL resource blocks allocated using the DCI, i.e. the resource blocks {7, 8, 9}.

Timeslot 1:

n_{PRB}^{s2}(i)=N_{RB}^{UL}−1−n_{PRB}^{s1}(i) =50−1−{7,8,9}={40,41,42}

Block D: The UE transmits the UL data utilizing the mapped-out physical resource blocks.

At this point, the method in embodiments of the present invention is finished.

It can be seen from the description of the embodiments of the present invention that the UE may use the above method to maximize of the frequency diversity gain and further enhance the performances of the PUSCH while avoiding the collision with the PUSCH channel resources of the UE which is (Rel-8/9/10).

The foregoing only describes preferred examples of the present invention and is not used to limit the protection scope of the present invention. Any modification, equivalent substitution and improvement without departing from the spirit and principle of the present invention are within the protection scope of the present invention.

1. A method for uplink (UL) data transmission in a wireless communication system, the method comprising:
determining, by a User Equipment (UE), UL virtual resources allocated to the UE by an Evolved Node B (eNB) according to Downlink Control Information (DCI) used for scheduling UL physical resources sent from the eNB to the UE, wherein at least two Component Carriers (CC)s having different frame structure configurations are present in CCs configured for the UE;
determining, by the UE, the UL physical resources used for transmitting UL data after frequency hopping processing in a preset frequency domain when determining that the UL data is to be processed with frequency hopping processing according to the DCI, if the UL virtual resources allocated to the UE are located at UL sub-frames in a non-aggregation K of any wireless frame and located at the preset frequency domain;
transmitting, by the UE, the UL data to the eNB utilizing the determined UL physical resources which are processed with the frequency hopping processing and used for transmitting the UL data;
wherein an aggregation K is an aggregation of UL sub-frames which are determined according to configured and different CC frame structure configurations and used for feeding back Acknowledgment/Negative Acknowledgement (ACK/NACK) information, and wherein the preset frequency domain is an overlapping area of a Physical Uplink Control Channel (PUCCH) area of UL sub-frames in the aggregation K and a Physical Uplink Shared Channel (PUSCH) area of sub-frames in the non-aggregation K.

2. The method of claim 1, wherein determining whether the UL virtual resources allocated to the UE are located at the preset frequency domain comprises:
determining whether a UL virtual resource block m allocated to the UE satisfies a condition
$$m < {N}_{RB}^{HO} / 2 or m > {N}_{RB}^{UL} - \frac{{N}_{RB}^{HO}}{2} ;$$
and
determining that the UL virtual resources allocated to the UE are located at the preset frequency domain if the UL virtual resource block m satisfies the condition, otherwise determining that the UL virtual resources allocated to the UE are not located at the preset frequency domain;
wherein N_{RB}^{UL} is a total number of Resource Blocks (RB)s in a UL system bandwidth, and N_{RB}^{HO} is an offset of frequency hopping issued by the system.

3. The method of claim 1, wherein determining, by the UE, the UL physical resources used for transmitting the UL data after the frequency hopping processing in the preset frequency domain comprises:
determining n_{PRB}^{s2}(i)=N_{RB}^{UL}−1−n_{PRB}^{s1}(i),
wherein n_{PRB}^{s2}(i) is a position of a UL physical resource which is used for transmitting the UL data after the frequency hopping processing, n_{PRB}^{s1}(i) is a position of a UL virtual resource allocated to the UE, N_{RB}^{UL} is a total number of RBs in the UL system bandwidth, and i is a number of the UL virtual resources allocated to the UE.

4. A User Equipment (UE) for transmitting uplink (UL) data in a wireless communication system, the UE comprising:
control circuitry configured to:
determine, by a UE, UL virtual resources allocated to the UE by an Evolved Node B (eNB) according to Downlink Control Information (DCI) used for scheduling UL physical resources sent from the eNB to the UE, wherein at least two Component Carriers (CC)s having different frame structure configurations are present in CCs configured for the UE, and
determine the UL physical resources used for transmitting UL data after frequency hopping processing in a preset frequency domain when determining that the UL data is to be processed with frequency hopping processing according to the DCI, if the UL virtual resources allocated to the UE are located at UL sub-frames in a non-aggregation K of any wireless frame and located at the preset frequency domain; and
a transmitter configured to transmit the UL data to the eNB utilizing the determined UL physical resources which are processed with the frequency hopping processing and used for transmitting the UL data,
wherein an aggregation K is an aggregation of UL sub-frames which are determined according to configured and different CC frame structure configurations and used for feeding back Acknowledgment/Negative Acknowledgement (ACK/NACK) information, and wherein the preset frequency domain is an overlapping area of a Physical Uplink Control Channel (PUCCH) area of UL sub-frames in the aggregation K and a Physical Uplink Shared Channel (PUSCH) area of sub-frames in the non-aggregation K.

5. The UE of claim 4, wherein the control circuitry is configured to:
determine whether a UL virtual resource block m allocated to the UE satisfies a condition
$$m < {N}_{RB}^{HO} / 2 or m > {N}_{RB}^{UL} - \frac{{N}_{RB}^{HO}}{2} ;$$
and
determine that the UL virtual resources allocated to the UE are located at the preset frequency domain if the UL virtual resource block m satisfies the condition, otherwise determining that the UL virtual resources allocated to the UE are not located at the preset frequency domain;
wherein N^{RB}^{UL} is a total number of Resource Blocks (RB)s in a UL system bandwidth, and N_{RB}^{UL} is an offset of frequency hopping issued by the system.

6. The UE of claim 4, wherein the control circuitry is configured to determine the UL physical resources used for transmitting the UL data after the frequency hopping processing in the preset frequency domain using:
n_{PRB}^{s2}(i)=N_{RB}^{UL}−1−n_{PRB}^{s1}(i)
wherein n_{PRB}^{s2}(i) is a position of a UL physical resource which is used for transmitting the UL data after the frequency hopping processing, n_{PRB}^{s1}(i) is a position of a UL virtual resource allocated to the UE, N_{RB}^{UL} a total number of RBs in the UL system bandwidth, and i is a number of the UL virtual resources allocated to the UE.

7. A wireless communication system, comprising:
an Evolved Node B (eNB); and
a User Equipment (UE) configured to:
determine, by a UE, UL virtual resources allocated to the UE by the eNB according to Downlink Control Information (DCI) used for scheduling UL physical resources sent from the eNB to the UE, wherein at least two Component Carriers (CC)s having different frame structure configurations are present in CCs configured for the UE, and
determine the UL physical resources used for transmitting UL data after frequency hopping processing in a preset frequency domain when determining that the UL data is to be processed with frequency hopping processing according to the DCI, if the UL virtual resources allocated to the UE are located at UL sub-frames in a non-aggregation K of any wireless frame and located at the preset frequency domain; and
transmit the UL data to the eNB utilizing the determined UL physical resources which are processed with the frequency hopping processing and used for transmitting the UL data,
wherein an aggregation K is an aggregation of UL sub-frames which are determined according to configured and different CC frame structure configurations and used for feeding back Acknowledgment/Negative Acknowledgement (ACK/NACK) information, and wherein the preset frequency domain is an overlapping area of a Physical Uplink Control Channel (PUCCH) area of UL sub-frames in the aggregation K and a Physical Uplink Shared Channel (PUSCH) area of sub-frames in the non-aggregation K.

8. The wireless communication system of claim 4, wherein the UE is configured to:
determine whether a UL virtual resource block m allocated to the UE satisfies a condition
$$m < {N}_{RB}^{HO} / 2 or m > {N}_{RB}^{UL} - \frac{{N}_{RB}^{HO}}{2} ;$$
and
determine that the UL virtual resources allocated to the UE are located at the preset frequency domain if the UL virtual resource block m satisfies the condition, otherwise determining that the UL virtual resources allocated to the UE are not located at the preset frequency domain;
wherein N^{RB}^{UL} is a total number of Resource Blocks (RB)s in a UL system bandwidth, and N_{RB}^{HO} is an offset of frequency hopping issued by the system.

9. The wireless communication system of claim 4, wherein the UE is configured to determine the UL physical resources used for transmitting the UL data after the frequency hopping processing in the preset frequency domain using:
n_{PRB}^{s2}(i)=N_{RB}^{UL}−1−n_{PRB}^{s1}(i),
wherein n_{PRB}^{s2}(i) is a position of a UL physical resource which is used for transmitting the UL data after the frequency hopping processing, n_{PRB}^{s1}(i) is a position of a UL virtual resource allocated to the UE, N_{RB}^{UL} is a total number of RBs in the UL system bandwidth, and i is a number of the UL virtual resources allocated to the UE.
